(19) United States
(12) Patent Application Publication
(10) Pub. No.: US 2013/0162065 A1
(43) Pub. Date: Jun. 27, 2013

(54) SPINDLE MOTOR

(71) Applicant: SAMSUNG ELECTRO-MECHANICS CO., LTD., Suwon (KR)

(72) Inventor: Kyu Hong Cho, Suwon (KR)

(73) Assignee: SAMSUNG ELECTRO-MECHANICS CO., LTD., Suwon (KR)

(21) Appl. No.: 13/716,626

(22) Filed: Dec. 17, 2012

(30) Foreign Application Priority Data
Dec. 26, 2011 (KR) 10-2011-0142647

(51) Int. Cl. H02K 5/16

(52) U.S. Cl. CPC H02K 5/165
USPC 310/45

(57) ABSTRACT

Disclose herein is a spindle motor, including: a shaft including a top thrust plate disposed at a top portion thereof and a bottom thrust plate disposed at a bottom portion thereof; a sleeve formed in a hollow cylindrical shape so as to be rotatably supported by the shaft and including a ring shaped convex part formed along an outer peripheral surface thereof; a base including a cylindrical support part formed at the center thereof and supporting the sleeve using a hollow part formed at the center of the support part; and a hub having a cylindrical part fixed to an upper end portion of the sleeve, a disk part extended from the cylindrical part in an outward direction, and a skirt part extended from an edge of the disk part in a vertical downward direction.

### CROSS REFERENCE TO RELATED APPLICATION

This application claims the benefit of Korean Patent Application No. 10-2011-0142647, filed on Dec. 26, 2011, entitled “Spindle Motor”, which is hereby incorporated by reference in its entirety into this application.

### BACKGROUND OF THE INVENTION

1. Technical Field

The present invention relates to a spindle motor.

2. Description of the Related Art

An information recording and reproducing apparatus, for example, a hard disk drive for a server is mounted with a shaft fixed type spindle motor. In the shaft fixed type spindle motor, a shaft having impact resistance is fixed in a box of the hard disk drive.

In the shaft fixed type spindle motor, the shaft is fixedly installed in order to prevent data written in a server from being damaged or being unwritable and/or unreadable due to external impact.

Patent Document 1 (Korean Patent No. 10-0200598) has disclosed “Spindle Motor Having Improved Structure”, particularly, a shaft fixed type spindle motor.

Currently, in this type of shaft fixed type spindle motor, a fluid, for example, oil is injected into a clearance in the spindle motor in order to configure a hydrodynamic bearing assembly.

In the case of the hydrodynamic bearing assembly of the spindle motor according to the prior art, a structure is significantly complicated, and an oil leakage phenomenon is continuously generated, such that an oil retention amount is decreased.

Patent Document 1: Korean Patent No. 10-0200598

### SUMMARY OF THE INVENTION

The present invention has been made in an effort to provide a spindle motor capable of stably maintaining an oil retention amount in a hydrodynamic bearing assembly.

According to a preferred embodiment of the present invention, a labyrinth sealing is formed to prevent evaporation of oil in a saturated vapor phase in a shaft fixed type spindle motor.

To this end, the spindle motor according to the preferred embodiment of the present invention includes: a shaft including a top thrust plate disposed at a top portion thereof and a bottom thrust plate disposed at a bottom portion thereof; a sleeve formed in a hollow cylindrical shape so as to be rotatably supported by the shaft and including a ring shaped convex part formed along an outer peripheral surface thereof; a base including a cylindrical support part formed at the center thereof and supporting the sleeve using a hollow part formed at the center of the support part; and a hub having a cylindrical part fixed to an upper end portion of the sleeve, a disk part extended from the cylindrical part in an outward direction, and a skirt part extended from an edge of the disk part in a vertical downward direction, wherein the support part of the base is disposed to be close to the convex part of the sleeve and the cylindrical part of the hub to form the labyrinth sealing.

According to the preferred embodiment of the present invention, an edge of the convex part and an outer peripheral surface of the cylindrical part should be spaced apart from the support part by a fine interval. To this end, according to the preferred embodiment of the present invention, the convex part and the cylindrical part have the same level.

According to the preferred embodiment of the present invention, the shaft includes a depression groove formed on an outer peripheral surface thereof. This depression groove may divide oil filled in a clearance between the shaft and the sleeve into top oil and bottom oil through external air. Alternatively, the depression groove may also be formed on an inner peripheral surface of the sleeve.

According to the preferred embodiment of the present invention, internal pressure at the clearance between the shaft and the sleeve and external pressure at the outside become the same as each other through a communication hole. This communication hole is formed in a hollow pipe shape in which it transverses a body of the sleeve.

In addition, according to the preferred embodiment of the present invention, a concave part is formed on an inner peripheral surface of the support part to vary a cross-sectional area between the convex part of the sleeve of the cylindrical part of the hub that are close to the inner peripheral surface of the support part, thereby making it possible to maximize a labyrinth sealing effect.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic cross-sectional view of a spindle motor according to a first preferred embodiment of the present invention;

FIG. 2 is a partially enlarged cross-sectional view of the spindle motor shown in FIG. 1; and

FIG. 3 is a cross-sectional view showing a portion of a spindle motor according to a second preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

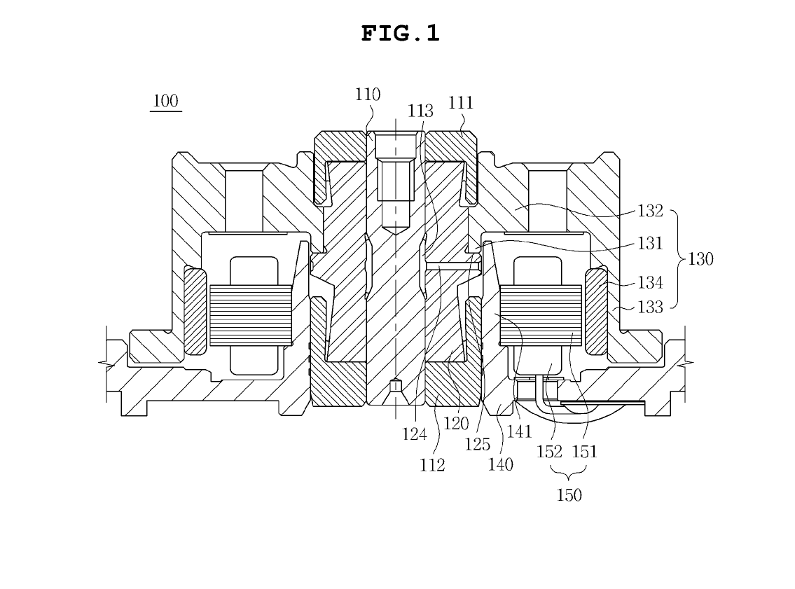

FIG. 1 is a schematic cross-sectional view of a spindle motor according to a first preferred embodiment of the present invention.

Referring to FIG. 1, the spindle motor 100 according to the preferred embodiment is configured to include a shaft 110, a sleeve 120, a rotor, and a stator.

The shaft 110 includes a top thrust plate 111 coupled to a top portion thereof and a bottom thrust plate 112 coupled to a bottom portion thereof and is inserted into a hollow part of a sleeve 120 to be described below. As shown in FIG. 1, the shaft 110 includes a depression groove 113 formed on an outer peripheral surface thereof.

The sleeve 120 has a generally cylindrical shape, includes the shaft 110 inserted thereinto, and is rotatably supported by the shaft 110. Particularly, it is preferable that the sleeve 120 is spaced apart from the shaft 110 by a predetermined interval, such that it is maintained in a state in which it does not contact the shaft 110, in order to decrease contact frictional force between the sleeve 120 and the outer peripheral surface. In addition, a clearance between the sleeve 120 and the shaft 110 may be filled with a fluid, preferably, oil, and a hydrodynamic bearing capable of decreasing friction between the sleeve 120 and the shaft 110 at the time of rotation of the sleeve 120 is formed through the oil.

Further, the sleeve 120 includes step parts each formed at an outer peripheral surface of a top portion thereof and an outer peripheral surface of a bottom portion thereof. The top step part seats the top thrust plate 111 thereon, and the bottom step part seats the bottom thrust plate 112 thereon.

The sleeve 120 having the cylindrical shape includes a communication hole 124 formed therein so as to traverse a body thereof More specifically, the communication hole 124 is formed in a pipe shape between an outer peripheral surface and an inner peripheral surface of the sleeve 120 to assist in allowing internal pressure generated in the clearance between the shaft 110 and the sleeve 120 and external pressure of the sleeve 120 to be the same as each other.

The rotor is fixed to an upper end portion of the sleeve 120 disposed to coincide with the center of rotation of a hub 130 by various schemes such as a press-fitting scheme, an adhesion scheme, or the like, wherein the hub 130 has a cylindrical part 131, a disk part 132, and a skirt part 133. The cylindrical part 131 is fixed to the upper end portion of the sleeve 120, and preferably supports the top thrust plate 111. The disk part 132 is extended from the cylindrical part 131 in an outward direction, and the skirt part 133 is extended from an edge of the disk part 132 in a vertical downward direction, that is, an axial direction and includes a ring shaped magnet 134 provided on an inner peripheral surface thereof.

The stator includes an armature 150 seated on a base 140, wherein the armature 150 includes a core 151 and a coil 152 and is disposed to face the magnet 134.

The base 140 includes a cylindrical support part 141 formed at the center thereof, and the sleeve 120 is inserted into and supported by a hollow part formed at the center of the support part 141. The support part 141 includes an electric field holder part (a reference numeral is not granted) stepped at an outer peripheral surface thereof so as to seat a core holder thereon and has an inner peripheral surface supporting the bottom thrust plate 112 together with the sleeve 120.

Alternatively, the base 140 may also close a bottom portion of the hollow part of the support part 141 so as to fix a position of a lower end portion of the shaft 110 and support and maintain the bottom thrust plate 112.

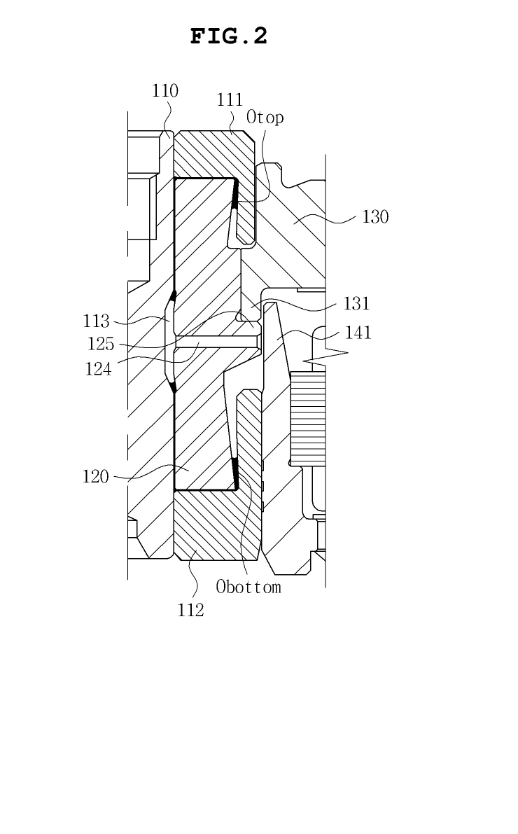

FIG. 2 is a partially enlarged cross-sectional view of the spindle motor shown in FIG. 1.

FIG. 2, which is an enlarged view of a hydrodynamic bearing of the spindle motor, shows an oil interface between the shaft 110 and the sleeve 120.

First, the depression groove 113 of the shaft 110 is formed along the outer peripheral surface of the shaft 110 and divides oil injected between the shaft 110 and the sleeve 120 into top oil Oₜₒₚ and bottom oil O_{bottom} in the axial direction of the shaft 110. Preferably, the depression groove 113 may be disposed at the same height as that of the communication hole 124 of the sleeve 120, such that it may be in communication with the outside.

Alternatively, the depression groove 113 may also be formed on an inner peripheral surface of the sleeve.

The top oil Oₜₒₚ is filled in clearances between the top portion of the shaft 110 and the inner peripheral surface of the sleeve 120 and between the upper end surface of the sleeve 120 and the top thrust plate 111 to form the hydrodynamic bearing, and forms an oil interface between the top thrust plate 111 and the sleeve 120 simultaneously with forming an oil interface at a top portion of the depression groove 113.

The bottom oil O_{bottom} is filled in clearances between the bottom portion of the shaft 110 and the inner peripheral surface of the sleeve 120 and between the lower end surface of the sleeve 120 and the bottom thrust plate 112 to form the hydrodynamic bearing, and forms an oil interface between the bottom thrust plate 112 and the sleeve 120 simultaneously with forming an oil interface at a bottom portion of the depression groove 113.

When the spindle motor is driven, a temperature of the oil rises, such that the oil may be evaporated in a saturated vapor phase. As the oil is evaporated, an amount of oil retained in the spindle motor may be decreased to cause damage or poor rotation of the spindle motor.

Particularly, when the saturated phase is continued, the bottom oil O_{bottom} is evaporated through a gap between the support part 141 of the base 140 (See FIG. 1) and the cylindrical part 131 of the hub 130.

In order to prevent leakage of the oil as much as possible, the present invention is characterized in that the support part 141 of the base is further extended in a vertical upward direction to be disposed to be close to one side of the hub, thereby generating a labyrinth sealing phenomenon in the clearance.

More specifically, the support part 141 is extended to be overlapped with one side, for example, the cylindrical part 131, of the hub 130.

The sleeve 120 may include a ring shaped convex part 125 formed along the outer peripheral surface thereof to be disposed to be close to the inner peripheral surface of the support part 141.

The convex part 125 of the sleeve 120 and the cylindrical part 131 of the hub 130 have the same level so that the convex part 125 and the cylindrical part 131 may be disposed to be spaced apart from the inner peripheral surface of the support part 141 by a fine interval.

The labyrinth sealing formed through the clearance between the support part 141 and the cylindrical part 131 and the clearance between the support part 141 and the convex part 125 of the sleeve 120 allows the oil in the saturated vapor phase not to contact the air as much as possible to conserve the oil through prevention of the leakage of the oil, thereby making it possible to improve durability of the spindle motor.

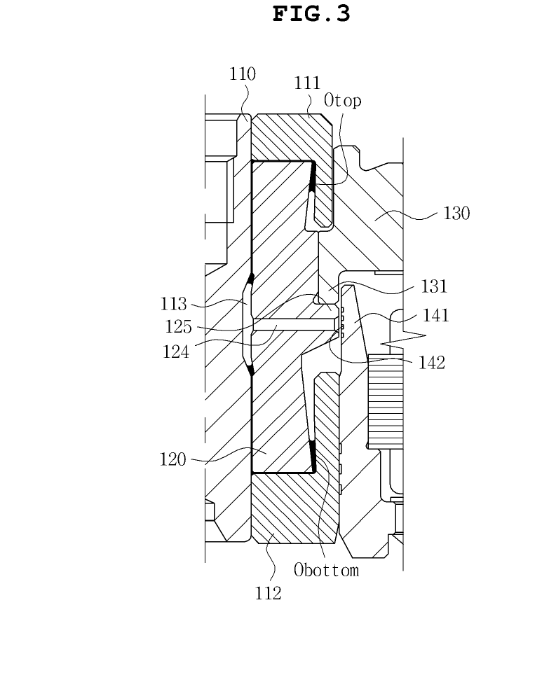

FIG. 3 is a schematic cross-sectional view of a spindle motor according to a second preferred embodiment of the present invention.

According to the preferred embodiment of the present invention, as described above, the cylindrical support part 141 formed at the center of the base 140 (See FIG. 1) is extended to decrease a contact area between the oil and the air, thereby preventing an evaporation phenomenon.

Particularly, in the second preferred embodiment of the present invention, a ring shaped concave part 142 is formed along the inner peripheral surface of the support part 141. Preferably, the concave part 142 is formed in the inner peripheral surface of the support part 141 facing the outer peripheral surface of the cylindrical part 131 of the hub 130 and varies a size of a cross-sectional area in a clearance between the support part 141 and the cylindrical part 131 to generate a labyrinth sealing effect, thereby making it possible to prevent evaporation of the bottom oil.

Furthermore, the concave part 142 is formed in the inner peripheral surface of the support part 141 facing an edge of the convex part 125 of the sleeve 120 and varies a size of a cross-sectional area in a clearance between the support part 141 and of the convex part 125 of the sleeve 120 to generate a more secure labyrinth sealing effect.

As set forth above, according to the preferred embodiment of the present invention, the hydrodynamic bearing is formed between the shaft and the sleeve, thereby making it possible to prevent evaporation of the oil.

In addition, according to the preferred embodiment of the present invention, only the length of the support part is extended, thereby making it possible to form the labyrinth sealing without a separate component.

Further, according to the preferred embodiment of the present invention, the evaporation of the oil is prevented by the labyrinth sealing, thereby making it possible to conserve rotational characteristics and durability of the motor.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A spindle motor for preventing leakage of oil through a labyrinth sealing, comprising:
a shaft including a top thrust plate disposed at a top portion thereof and a bottom thrust plate disposed at a bottom portion thereof;
a sleeve formed in a hollow cylindrical shape so as to be rotatably supported by the shaft;
a hub having a cylindrical part extended downwardly so as to be fixed to an upper end portion of the sleeve, a disk part extended from the cylindrical part in an outward direction, and a skirt part extended from an edge of the disk part in a vertical downward direction; and
a base including a cylindrical support part formed at the center thereof and extended to be overlapped with the cylindrical part of the hub, having a fine interval therebetween, and supporting the sleeve using a hollow part formed at the center of the support part.

2. The spindle motor as set forth in claim 1, wherein the sleeve includes a ring shaped convex part formed along an outer peripheral surface thereof.

3. The spindle motor as set forth in claim 2, wherein an edge of the convex part and an outer peripheral surface of the cylindrical part have the same level.

4. The spindle motor as set forth in claim 2, wherein the support part is disposed to be overlapped with the cylindrical part of the hub, having the fine interval therebetween, at the convex part of the sleeve.

5. The spindle motor as set forth in claim 1, wherein the shaft includes a depression groove formed on an outer peripheral surface thereof.

6. The spindle motor as set forth in claim 1, wherein the sleeve includes a communication hole formed therein so as to traverse a body thereof.

7. The spindle motor as set forth in claim 6, wherein the communication hole is in communication with the depression groove.

8. The spindle motor as set forth in claim 1, wherein the support part includes a ring shaped concave part formed along an inner peripheral surface thereof.

9. The spindle motor as set forth in claim 8, wherein the concave part is formed at the support part facing an edge of the convex part and an outer peripheral surface of the cylindrical part.
